(19) United States
(12) Patent Application Publication
(10) Pub. No.: US 2009/0293230 A1
(43) Pub. Date: Dec. 3, 2009

(54) HINGE STRUCTURE WITH A FLEXIBLE LOCKING ASSEMBLY

(75) Inventor: LIN-KAI HUNG, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: PROTORSION HINGE CO., LTD., TAIPEI COUNTY (TW)

(21) Appl. No.: 12/141,498

(22) Filed: Jun. 18, 2008

(30) Foreign Application Priority Data
Jun. 2, 2008 (TW) 097209626

(51) Int. Cl. E05D 11/10

(52) U.S. Cl. 16/347; 16/343

(57) ABSTRACT

A hinge structure is provided to include a knuckle, a pivot shaft and a flexible locking assembly. The pivot shaft extends rotatably into the knuckle, and has a peripheral locking section and a peripheral working section having a straight line. A flexible locking assembly is disposed within the knuckle, and includes a flexible element and a roller unit. The flexible element has a seating portion and one flexible leg extending from the seating portion in such a manner to contact the knuckle. The roller unit is disposed between the seating portion and the pivot shaft.

### FIELD OF THE INVENTION

The present invention relates to a hinge structure, and more particularly to a hinge structure having a flexible locking assembly.

### BACKGROUND OF THE INVENTION

In our daily life, a hinge structure is implemented when two elements are required to be folded relative to each other. The hinge structure available presently generally consists of a male member and a female member. The male member generally includes a pivot shaft and a connection portion while the female member includes a knuckle and a connection portion. Under the normal condition, the pivot shaft extends rotatably into the knuckle while one object is mounted on the connection portion. Another object is mounted on the connection portion of female member such that the two objects can be folded onto or unfolded away from each other about an axis of the pivot shaft.

In actual practice, a positioning device is disposed between the pivot shaft and the knuckle in order to lock the male and female members together. The most commonly know positioning devices include flexible elements, hooks, mortise and dovetail structures and groove-and-tongue engagements.

FIG. 1 shows an exploded view of a conventional hinge structure. FIG. 2 shows a cross-sectional view of the conventional hinge structure in a working condition. FIG. 3 shows a cross-sectional view of the conventional hinge structure in a locking condition. As illustrated, the conventional hinge structure 1 includes a female member 11, a male member 12 and a flexible unit 13.

The female member 11 has a knuckle 111 and a connection portion 112 extending from the knuckle 111. The connection portion 112 is formed with two connection holes 1121, 1122. The male member 12 has a pivot shaft 121 extending rotatably into the knuckle 111 and a connection portion 122 extending from the pivot shaft 121. The male member 12 further has a connection portion 122 extending from the pivot shaft 121 and formed with two connection holes 1221, 1222. The pivot shaft 121 when in cross section has an axis AO and defines a peripheral locking section 1211 and a peripheral working section 1212 adjacent to the peripheral locking section 1211. The peripheral locking section 1211 includes a straight line. Alternately the peripheral locking section 1211 extends along a straight line.

The flexible unit 13 is disposed within the knuckle 111, and has seating section 131 in the form of a recess for receiving the pivot shaft 121 and two flexible parts 132, 133 extending from the seating section 131 in such a manner to contact the knuckle 111. The seating section 131 has a width smaller than the length of the working section 1212. 1212

Referring to FIG. 2, when the peripheral working section 1212 is aligned with the seating section 131, the pivot shaft 121 possesses a torque due to said biasing action of said flexible unit 13. At this time, the conventional hinge structure 1 is disposed in the working state.

Referring to FIG. 3, in case the pivot shaft 121 is rotated within the knuckle 111 in the arrow direction (10) (i.e. about its axis AO) such that the peripheral locking section 1211 is aligned with the seating section 131, the pivot shaft 121 is locked to the knuckle 111 due interference between the width of the seating section 131 and the length of the peripheral locking section 1211. At this time, the conventional hinge structure 1 is disposed in the locking state.

As is known in the art, there always exist two turning angles C1, C2 between the peripheral locking section 1211 and a peripheral working section 1212 and another two turning angles C3,C4 between the seating section 131 and two flexible parts 132, 133.

Rotation of the pivot shaft 121 about its axis AO within the knuckle 111 results in severe wear whenever the turning angle C1,C2 of the pivot shaft 121 collides against the turning angle C3,C4 of the flexible unit 13, thereby preventing smooth rotation of the pivot shaft 121 in the knuckle 111 and consequently shortening the service life of the conventional hinge structure 1.

### SUMMARY OF THE INVENTION

The present invention is to provide a hinge structure that permit smooth rotation of a pivot shaft so as to eliminate the drawback of the prior art technology. The main object of the present invention is to provide a hinge structure including a roller unit disposed between the seating portion and the pivot shaft and simultaneously correct the periphery of the pivot shaft in such a manner to enable smooth rotation of the same.

In accordance with the present invention, a hinge structure is provided to include a knuckle, a pivot shaft and a flexible locking assembly. The pivot shaft extends into the knuckle, and has a peripheral locking section and a peripheral working section adjacent to the peripheral locking section. The flexible locking assembly is disposed within the knuckle, and includes a flexible element and a roller unit. The flexible element has a seating portion and at least one flexible leg extending from the seating portion in such a manner to contact the knuckle. The roller unit is disposed between the seating portion and the pivot shaft.

When the peripheral locking section is aligned with the roller unit, the pivot shaft is locked to the knuckle due to biasing action of the flexible element. When the peripheral working section of the pivot shaft is aligned with the roller unit, the pivot shaft possesses a torque due to the biasing action of the flexible element. The roller unit may include a cylindrical roller, a plurality of rolling balls or combination of the cylindrical roller and the rolling ball.

In the preferred embodiment of the present invention, the peripheral working section of the pivot shaft extends along a straight line and is located adjacent to the peripheral locking section. The pivot shaft further has two curve guide sections at adjoining areas between the peripheral working section and the peripheral locking section such that approach of the curved guide section toward the roller unit results in biasing action of the flexible element to the pivot shaft, thereby locking the pivot shaft relative to the knuckle.

When compared to the conventional hinge structure, the hinge structure of the present invention includes a roller unit disposed between the seating portion and the pivot shaft. The flexible element and the roller unit cooperatively define the flexible locking assembly. The pivot shaft employed in the preferred embodiment has a smooth periphery and is free of turning angles. The roller unit is circular in cross-section such that relative rotation between the pivot shaft and the roller unit enables smooth operation of the hinge structure of the present invention, thereby tremendously prolonging the service life thereof.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is an exploded view of a conventional hinge structure;

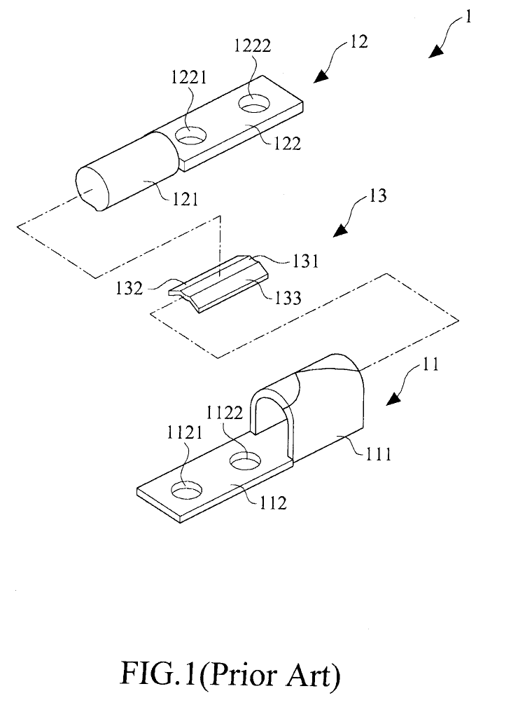

FIG. 2 is a cross-sectional view of the conventional hinge structure in a working condition;

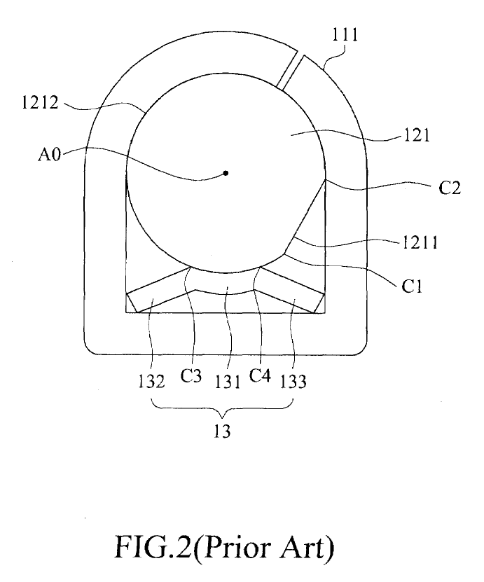

FIG. 3 is a cross-sectional view of the conventional hinge structure in a locking condition;

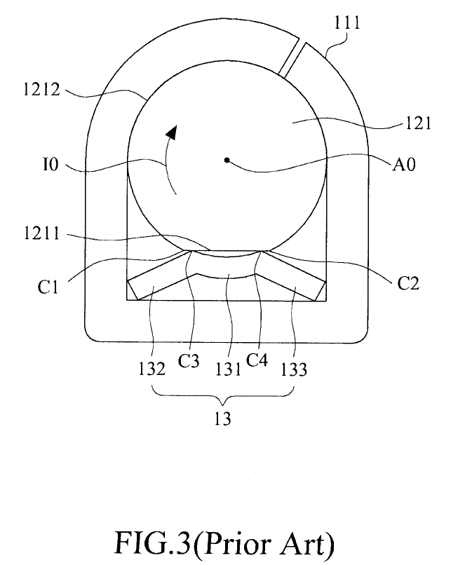

FIG. 4 is an exploded view of the first embodiment of a hinge structure of the present invention;

FIG. 5 is a cross-sectional view of the first embodiment of the hinge structure of the present invention in a locking condition;

FIG. 6 is a cross-sectional view of the first embodiment of the hinge structure of the present invention in a working condition;

FIG. 7 is a cross-sectional view of the second embodiment of the hinge structure of the present invention in a locking condition;

FIG. 8 shows an exploded view of a flexible locking assembly employed in the third embodiment of the hinge structure of the present invention;

FIG. 9 is a perspective and assembled view of the flexible locking assembly employed in the third embodiment of the hinge structure of the present invention;

FIG. 10 shows an exploded view of the flexible locking assembly employed in the fourth embodiment of the hinge structure of the present invention; and

FIG. 11 is a perspective and assembled view of the flexible locking assembly employed in the fourth embodiment of the hinge structure of the present invention.

### DETAILED DESCRIPTIONS OF THE PREFERRED EMBODIMENTS

The hinge structure 2 of the present invention is widely used in variety of structures when two elements are required to be folded relative to each other.

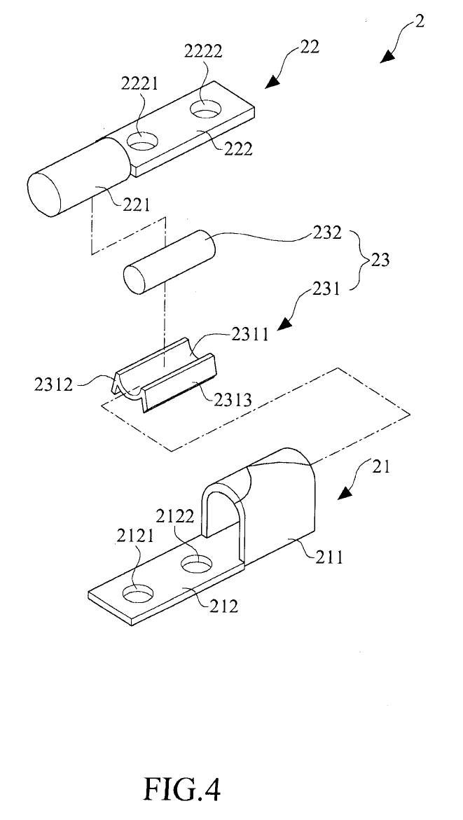

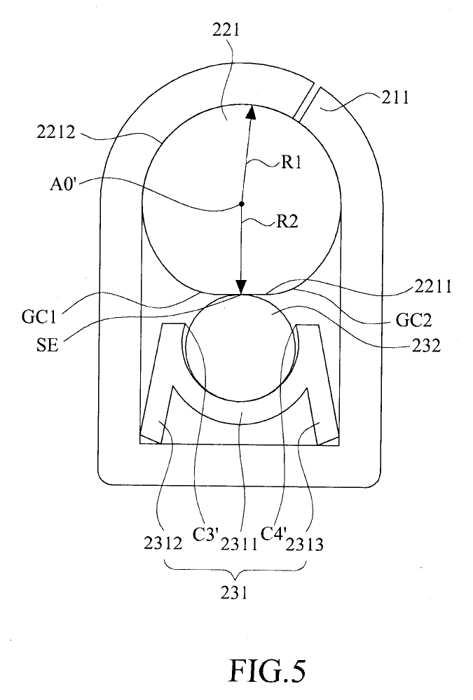

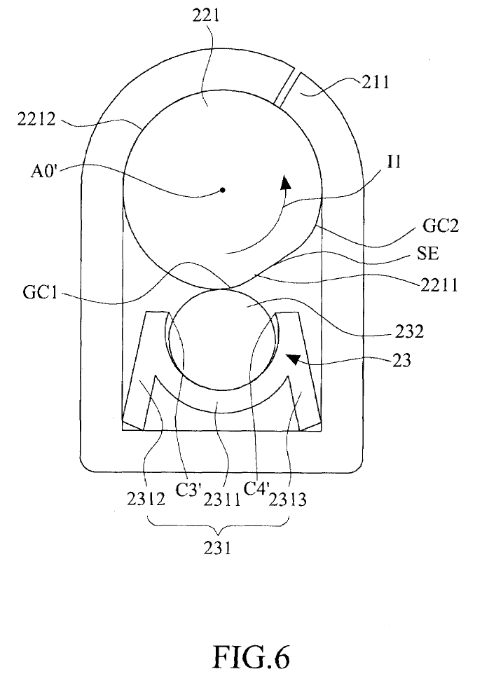

FIG. 4 is an exploded view of the first embodiment of a hinge structure of the present invention. FIG. 5 is a cross-sectional view of the first embodiment of the hinge structure of the present invention in a locking condition. FIG. 6 is a cross-sectional view of the first embodiment of the hinge structure of the present invention in a working condition. As illustrated, the hinge structure 2 accordingly includes a female member 21, a male member 22 and a flexible locking assembly 23.

The female member 21 includes a knuckle 211 and a female connection portion 212 extending from the knuckle 211. The female connection portion 212 is formed with two connection holes 2121, 2122 that are used for coupling with a first object (not show). The male member 22 includes a pivot shaft 221 extending into the knuckle 211, and has in cross-section an axis AO′ a peripheral locking section 2211 and a peripheral working section 2212. The male member 22 further includes male connection portion 222 extending from the pivot shaft 221 and formed with two connection holes 2221, 2222 that are used for coupling with a second object (not show). Thus, the first and second objects can be folded onto each other or unfolded relative to each other.

The peripheral working section 2212 extends along a straight line SE. In other words, the periphery of the pivot shaft 221 is generally circular except the peripheral working section 2212, which is located adjacent to the peripheral locking section 2211. The pivot shaft 221 has two curve guide sections GC1, GC2 disposed between and interconnecting the peripheral locking section 2211 and the peripheral working section 2212. In other words, the pivot shaft 221 is free of turning angles in cross section. The pivot shaft 221 further has an axis AO′ and defines a first distance R1 measured from the axis AO′ to the peripheral working section 2212 and a second distance R2 measured from the axis AO′ to the peripheral locking section 2211, where R1>R2.

The flexible locking assembly 23 is disposed within the knuckle 211 of the female member 21, and includes a flexible element 231 and a roller unit 232. The flexible element 231 has a seating portion 2311 and two flexible legs 2312, 2313 extending downward from two opposite sides of the seating portion 2311 in such a manner to contact the knuckle 211. The roller unit 232 is disposed in the seating portion 2311 and the pivot shaft 221. In the first embodiment, a cylindrical roller is used for the roller unit 232.

As illustrated in FIG. 5, the approach of the curve guide section GC1, GC2 of the locking section 2211 towards the roller unit 232 results in biasing action of the flexible element 231 against the pivot shaft 221, thereby aligning the peripheral locking section 2211 with the roller unit 232 and locking the pivot shaft 221 to the knuckle 211. Under this condition, the hinge structure 2 of the present invention is in the locked state.

As illustrated in FIG. 6, when the pivot shaft 221 is rotated relative to the knuckle 211 about the axis AO′ as shown by the arrow 11 so as to align the peripheral working section 2212 with the roller unit 232. At this time, the pivot shaft 221 possesses a torque due to the biasing action of the flexible element 231. Under this condition, the hinge structure 2 of the present invention is in the working state.

When compare to the conventional hinge structure, the pivot shaft of the present hinge structure has the straight locking section 2211 and two curve guide sections GC1, GC2 that slide smoothly over the roller unit 232 with circular cross section. In other words, rotation of the pivot shaft 221 within the knuckle 211 is smooth regardless of position of the pivot shaft 221 with respect to the knuckle 211, thereby prolonging the service life of the present hinge structure.

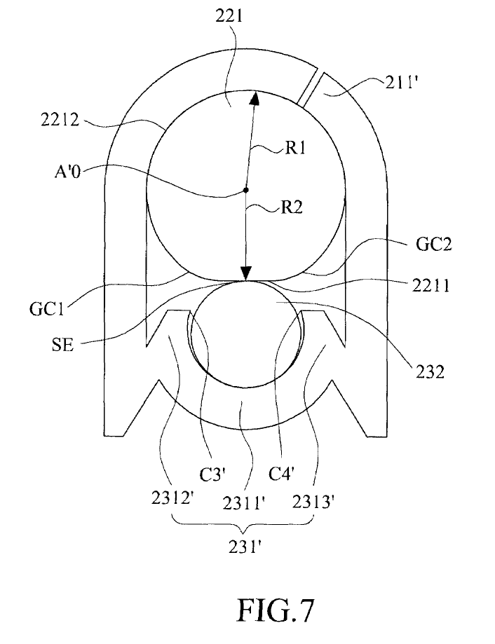

FIG. 7 is a cross-sectional view of the second embodiment of the hinge structure of the present invention in a locking condition. As illustrated, the flexible element 231′ has a seating portion 2311′ for receiving the roller unit 232 therein and two flexible legs 2312′, 2313′ extending from the seating portion 2311′ in such a manner and integrally formed with the knuckle 211′ of the female member.

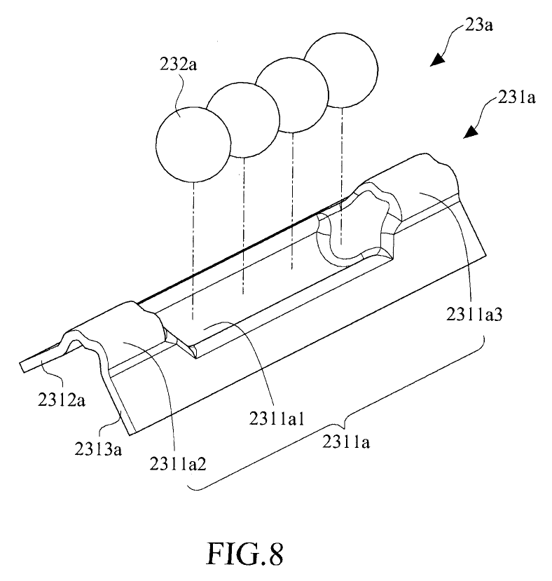

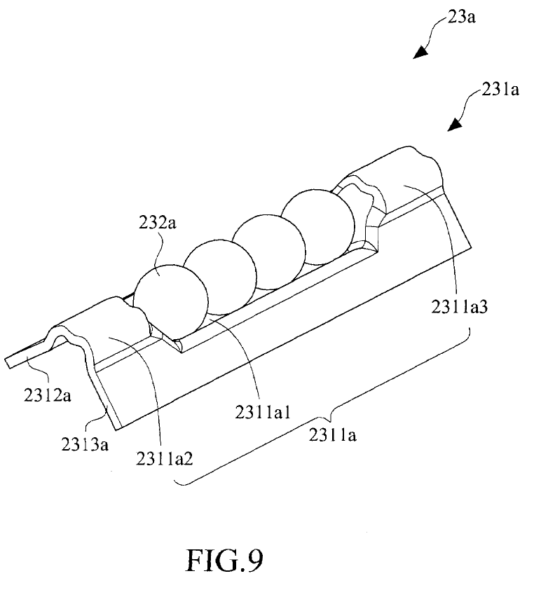

FIG. 8 shows an exploded view of a flexible locking assembly employed in the third embodiment of the hinge structure of the present invention. FIG. 9 is a perspective and assembled view of the flexible locking assembly employed in the third embodiment of the hinge structure of the present invention. The flexible locking assembly 23a includes a flexible element 231a and a plurality of rolling balls 232a substituting the roller unit 232.

The flexible element 231a has a seating portion 2311a in the form of a receiving chamber 2311a1 for receiving the rolling balls 232a (see FIG. 9) rotatably therein and two restriction elements 2311a2, 2311a3 at two opposite sides of the receiving chamber 2311a and protruded upward from the flexible legs 2312a, 2313a to prevent untimely removal of the rolling balls 232a from the receiving chamber 2311a1.

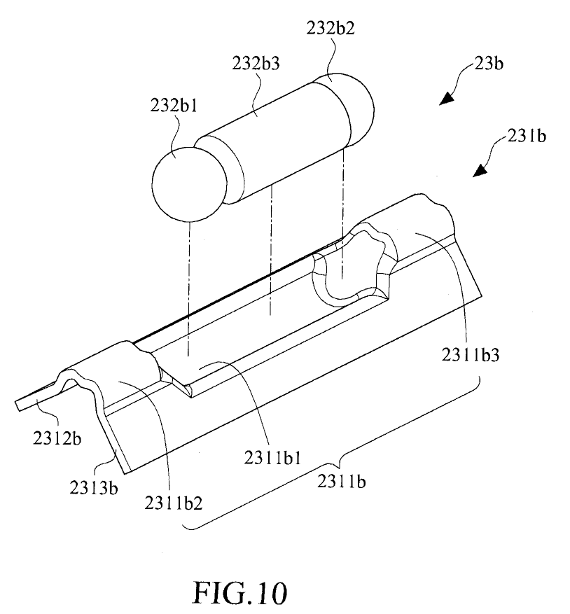

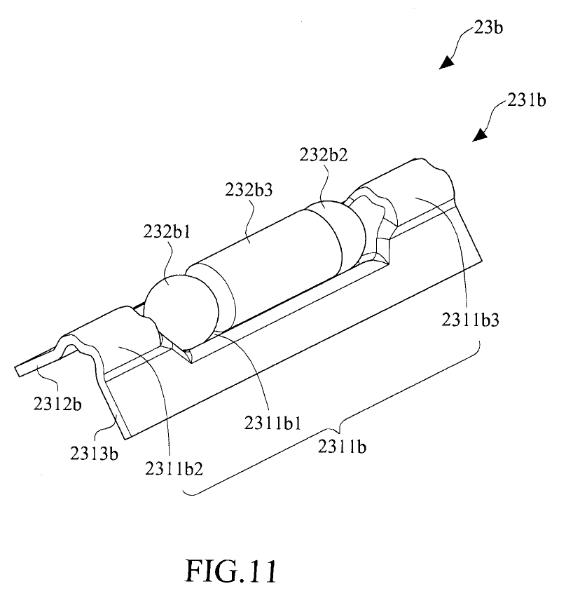

FIG. 10 shows an exploded view of the flexible locking assembly employed in the fourth embodiment of the hinge structure of the present invention. FIG. 11 is a perspective and assembled view of the flexible locking assembly employed in the fourth embodiment of the hinge structure of the present invention. The flexible locking assembly 23b includes a flexible element 231b, two rolling balls 232b1, 232b2 and a cylindrical roller 232b3 for substituting the roller unit 232.

The flexible element 231b has a seating portion 2311b in the form of a receiving chamber 2311b1 for receiving the cylindrical roller 232b3 and the rolling balls 232b1, 232b2 rotatably therein and two restriction elements 2311b2, 2311b3 at two opposite sides of the receiving chamber 2311b1 and protruded upward from the flexible legs 2312b, 231b so as to prevent untimely removal of the cylindrical roller 232b3 and the rolling balls 232b1, 232b2 from the receiving chamber 2311b1.

In the aforesaid flexible element 231a, 231b, the receiving chamber 2311a1, 2311b1 is formed by punching the middle portion thereof while two opposite sides of the receiving chamber is punched two times in order the restriction elements 2311a2, 2311a3, 2311b2, 2311b3.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A hinge structure comprising:
a knuckle;
a pivot shaft extending into said knuckle, and having a peripheral locking section and a peripheral working section adjacent to said peripheral locking section; and
a flexible locking assembly disposed within said knuckle, and including:
a flexible element having a seating portion and at least one flexible leg extending from said seating portion in such a manner to contact said knuckle, and
a roller unit disposed in said seating portion and said pivot shaft;
wherein, said pivot shaft is locked to said knuckle due to biasing action of said flexible element when said peripheral locking section is aligned with said roller unit and said pivot shaft possesses a torque due to said biasing action of said flexible element when said peripheral working section is aligned with said roller unit.

2. The hinge structure according to claim 1, wherein said peripheral working section includes a straight line.

3. The hinge structure according to claim 1, wherein said pivot shaft further has a curve guide section disposed between and interconnecting said peripheral locking section and said peripheral working section.

4. The hinge structure according to claim 1, wherein said pivot shaft has an axis and defines a first distance R1 measured from said axis to said peripheral working section and a second distance R2 measured from said axis to said peripheral locking section and where R1>R2.

5. The hinge structure according to claim 1, wherein said roller unit includes a cylindrical roller.

6. The hinge structure according to claim 1, wherein said roller unit includes a plurality of rolling balls.

7. The hinge structure according to claim 1, wherein said roller unit includes at least one cylindrical roller and at least one rolling ball.

8. The hinge structure according to claim 1, further comprising a female connection portion extending from and cooperating with said knuckle to form a female member.

9. The hinge structure according to claim 8, wherein said female connection portion is formed with at least one connection hole.

10. The hinge structure according to claim 1, further comprising a male connection portion extending from and cooperating with said pivot shaft to form a male member.

11. The hinge structure according to claim 10, wherein said male connection portion is formed with at least one connection hole.

12. The hinge structure according to claim 1, wherein said seating portion includes a receiving chamber for keeping said roller unit and two restriction elements disposed at two opposite sides of said receiving chamber and protruding upward from said flexible legs to prevent untimely removal of said roller unit from said receiving chamber.
